(19) United States
(12) Patent Application Publication
(10) Pub. No.: US 2024/0144052 A1
(43) Pub. Date: May 2, 2024

(54) AUTOMATED DECISION OPTIMIZATION FOR MAINTENANCE OF PHYSICAL ASSETS

(71) Applicant: INTERNATIONAL BUSINESS MACHINES CORPORATION, Armonk, NY (US)

(72) Inventors: Nianjun ZHOU, Chappaqua, NY (US); Pavankumar MURALI, Ardsley, NY (US); Dzung Tien PHAN, Pleasantville, NY (US); Lam Minh NGUYEN, Ossining, NY (US)

(21) Appl. No.: 18/051,070

(22) Filed: Oct. 31, 2022

(51) Int. Cl. G06N 5/04

(52) U.S. Cl. CPC G06N 5/04

(57) ABSTRACT

A maintenance solution pipeline is automatically selected from a plurality of maintenance solution pipelines, based on obtained information. The maintenance solution pipeline is to be used in providing a physical asset maintenance solution for a plurality of physical assets. Code and model rendering for the maintenance solution pipeline automatically selected is initiated. Output from an artificial intelligence process is obtained. The output includes an automatically generated risk estimation relating to one or more conditions of at least one physical asset of the plurality of physical assets. Code and model rendering for the maintenance solution pipeline is re-initiated, based on the output from the artificial intelligence process. The maintenance solution pipeline automatically selected is reused.

### BACKGROUND

One or more aspects relate, in general, to dynamic processing within a computing environment, and in particular, to improving such processing, as it relates to the maintenance of physical assets.

The maintenance of physical assets includes the planning and/or scheduling of maintenance for the assets. Although techniques to perform asset maintenance and other management tasks exist, those techniques vary widely for many reasons. For example, data is obtained from multiple sources at various levels of granularity. Further, predictive models are customized to specific asset classes, regions and network structures. The techniques are myopic in terms of scope, e.g., tailored for a sub-network instead of system wide. Yet further, there are operator objectives (e.g., repair only; replace or repair; replace, repair, reuse; maintenance planning; maintenance scheduling; etc.), operator constraints, and/or operational dynamics (e.g., asset health, demand patterns, risk tolerance, etc.) to be considered.

For a specific customer, optimization and decision support are to be adapted based on problem scope, time horizon, operational constraints, etc. For those without deep optimization skills, handling these dynamics may be time and effort intensive.

### SUMMARY

Shortcomings of the prior art are overcome, and additional advantages are provided through the provision of a computer-implemented method. The computer-implemented method includes automatically selecting a maintenance solution pipeline from a plurality of maintenance solution pipelines based on obtained information. The maintenance solution pipeline is to be used in providing a physical asset maintenance solution for a plurality of physical assets. Code and model rendering for the maintenance solution pipeline automatically selected is initiated. Output from an artificial intelligence process is obtained. The output includes an automatically generated risk estimation relating to one or more conditions of at least one physical asset of the plurality of physical assets. Code and model rendering for the maintenance solution pipeline is re-initiated, based on the output from the artificial intelligence process. The maintenance solution pipeline automatically selected is reused.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present invention;

FIG. 2 depicts one example of sub-modules of the automated decision optimization for asset maintenance module of FIG. 1, in accordance with one or more aspects of the present invention;

FIG. 3 depicts one example of processing to perform automated decision optimization, in accordance with one or more aspects of the present invention;

FIG. 4A depicts one example of further details of processing to perform automated decision optimization, in accordance with one or more aspects of the present invention;

FIG. 4B depicts one example of automated risk estimation, performed by an automated artificial intelligence process, used in performing automated decision optimization, in accordance with one or more aspects of the present invention;

FIG. 5 depicts one example of automated decision optimization, including automated optimization model creation, in accordance with one or more aspects of the present invention;

FIG. 6 depicts one example of automatically selecting a pipeline for automated decision optimization, in accordance with one or more aspects of the present invention;

FIG. 7 depicts one example of further details of automatically generating risk estimation for use in automated decision optimization, in accordance with one or more aspects of the present invention;

FIG. 8 depicts one example of a conceptual level for building/rebuilding an optimization model, in accordance with one or more aspects of the present invention;

FIG. 9 depicts one example of model transformation, in accordance with one or more aspects of the present invention;

FIG. 10 depicts one example of a tree structure (e.g., a directed acyclic graph) for building a model for automated decision optimization, in accordance with one or more aspects of the present invention;

FIG. 11 depicts one example of condition-based asset maintenance, in accordance with one or more aspects of the present invention;

FIG. 12 depicts one example of an overview of requesting and providing an optimized decision for a selected scenario, in accordance with one or more aspects of the present invention; and

FIG. 13 depicts one example of a machine learning training system used in accordance with one or more aspects of the present invention.

### DETAILED DESCRIPTION

In one or more aspects, a capability is provided to perform automated decision optimization for the maintenance of assets. As examples, the maintenance includes planning and/or scheduling maintenance for the assets. The maintenance may include one or more of a repair, replacement, reuse, inspection, preventive maintenance, etc. for the assets. The assets are, for instance, physical assets and may be within a computing environment, a manufacturing environment, a construction environment, a utility environment, a service environment, or any other environment that has physical assets. Example physical assets include computers, computer components, other types of machines or devices, components of other types of machines or devices, etc.

In one or more aspects, the maintenance is condition-based maintenance in which the condition of the assets is taken into consideration in the maintenance of the assets. Although examples described herein include condition-based maintenance of physical assets, other embodiments may include other maintenance and/or other management tasks of assets.

In one or more aspects, input to the automated decision optimization process is provided from an automated artificial intelligence process to facilitate generation of optimization models for asset maintenance for selected scenarios. The input includes, for example, risk estimation relating to the assets, including the condition (e.g., health) of the assets.

In one or more aspects, a data scientist, analyst, user, etc. (without deep optimization expertise) is able to automatically generate risk estimation and optimization pipelines to perform asset management, such as condition-based maintenance planning and/or scheduling for an asset fleet (i.e., a plurality of assets with certain similarities and/or some assets having interdependencies), based on, for instance, available input data, asset interdependencies (e.g., physical network based and/or resource constrained) and/or problem definition, over, e.g., a time horizon (e.g., one month plan or other time periods). A data scientist, analyst, user, etc. is provided the ability to create end-to-end risk estimation and maintenance planning/scheduling models and pipelines from data and knowledge. In one example, for a specific customer, optimization and decision support are adapted based on problem, scope, time horizon, operational constraints, etc. through a customization of pre-built optimization model pipelines. As examples, failure risk estimation/stochastic degradation models for automated model construction and knowledge specifications are combined to specify decision optimization inputs. The generation of an asset maintenance optimization model is streamlined with a proven methodology that can dramatically enhance productivity and reduce the time of turn-around for asset management (e.g., maintenance) model creation. Scalability and automation in creating decision optimization models increases the adaptability to scope, time horizon and real-time user inputs.

As an example, automated dynamic optimization asset fleet maintenance pipeline generation is achieved through using tree or graph structures for decision making. As used herein, tree and graph are used interchangeably. One example of a tree or graph structure used has an order, such as a directed acyclic graph; other tree and/or graph structures may be used. In one aspect, a graph framework is used to choose a selected pipeline of one or more pipelines. A process of problem definition to risk and optimization modeling is outlined. User inputs and derived information on problem definition determine the relevant branch of the graph to be traversed. The selected pipeline (e.g., a best pipeline, based on preselected criteria) is determined by, e.g., input data and a selected asset maintenance solution. The selected pipeline codifies and automates the workflow to produce a decision optimization model based on, e.g., one or more requirements (e.g., business requirements). The output of such a pipeline is e.g., a decision support for the time schedule for a fleet asset with an action of maintenance, which includes, for instance, repair, replace, inspect, reuse and/or preventive maintenance, etc.

In one or more aspects, for a given pipeline, a tree structure is used to manage optimization model building and rebuilding. In one example, creation of an optimization model is triggered by an update to a risk model or estimates based on, for instance, real-time data inflow and/or user inputs. For the tree structure, in one example, a root node represents data collection, preprocessing, imputation, etc.; leaf nodes represent, e.g., an optimization pipeline based on the choice of the risk estimation technique; and non-leaf nodes are annotated, for instance, as operations to define mathematical representations based on numerical specification, user-defined constraints and objectives. For each non-leaf node, a repository for storing the intermediate model is defined. In one or more aspects, based on an update to the risk model or risk estimate, code and model rendering are re-initiated, but the selected pipeline is reused.

In one or more aspects, an optimization model update or creation is completed through tree traversal of, e.g., a directed acyclic graph. Such a tree traversal defines a specific path of uncertainty reduction for optimization formulation. The tree traversal is converted to an execution pipeline via, e.g., auto-generation. In one or more aspects, the tree traversal includes converting the optimization model creation as a process of uncertainty reduction from an abstract mathematical model to a specific business scenario model.

In one or more aspects, the tree structure is interpretable due to the graph/tree structure.

In one or more aspects, model reuse is provided in which the creation of optimization pipelines is simplified by regenerating an existing optimization pipeline with necessary/desired changes to the mathematical representation of constraints and objectives.

In one or more aspects, model rebuild is provided in which, for deployment purposes, data inflow (as batch or real-time) is provided to re-train risk models and obtain updated risk estimates for assets. This, in turn, is expected to trigger the optimization model to develop an updated plan/schedule.

In one or more aspects, predictive models for potential risk failure are customized to specific asset classes, regions, network structures, and/or system-wide.

One or more aspects of the present invention are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing a process (or multiple processes) that, e.g., performs automated decision optimization for the management (e.g., maintenance) of assets and/or performs one or more other aspects of the present invention. Aspects of the present invention are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

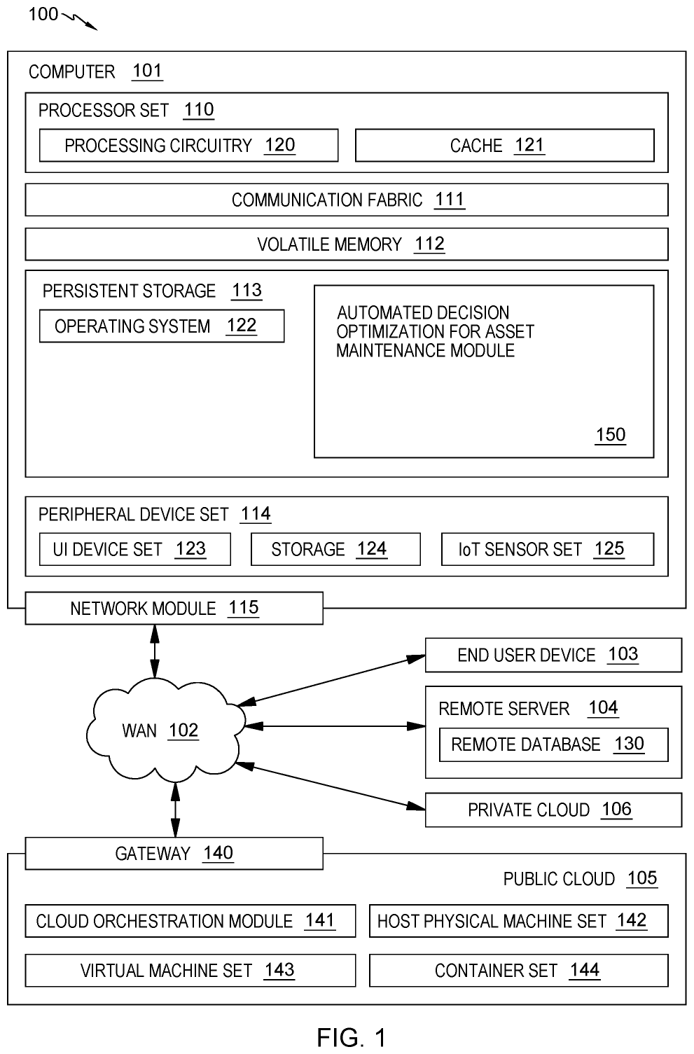

One example of a computing environment to perform, incorporate and/or use one or more aspects of the present invention is described with reference to FIG. 1. In one example, a computing environment 100 contains an example of an environment for the execution of at least some of the computer code involved in performing the inventive methods, such as automated decision optimization for asset management code or module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present invention. Other examples are possible. For instance, in one or more embodiments, one or more of the components/modules of FIG. 1 are not included in the computing environment and/or are not used for one or more aspects of the present invention. Further, in one or more embodiments, additional and/or other components/modules may be used. Other variations are possible.

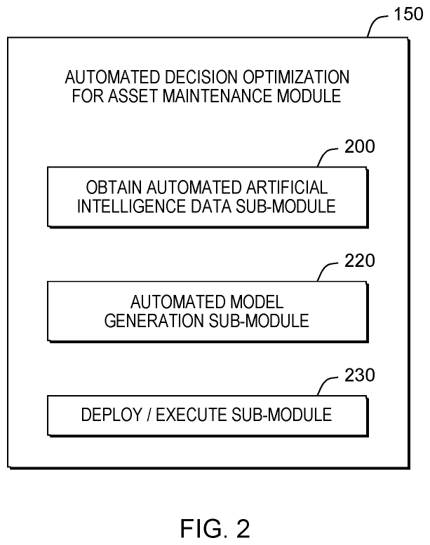

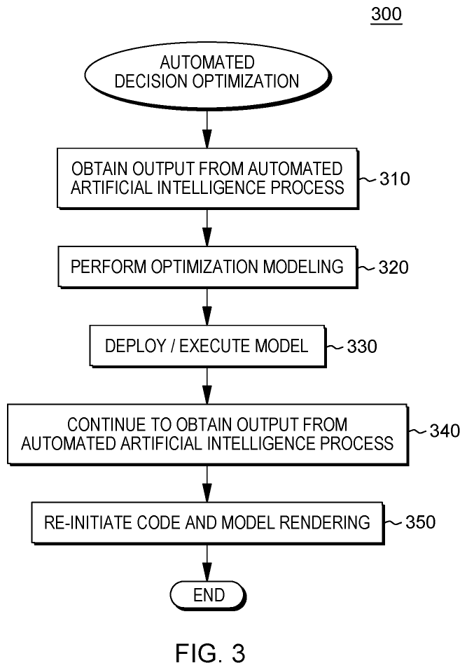

Further details relating to automated decision optimization for asset maintenance are described with reference to FIGS. 2-3. FIG. 2 depicts further details of an automated decision optimization for asset maintenance module (e.g., automated decision optimization for asset maintenance module 150 of FIG. 1) that includes code or instructions used to perform automated decision optimization for asset maintenance, in accordance with one or more aspects of the present invention, and FIG. 3 depicts one embodiment of a process to perform automated decision optimization for asset maintenance, in accordance with one or more aspects of the present invention.

In one or more aspects, referring to FIG. 2, an automated decision optimization for asset maintenance module (e.g., automated decision optimization for asset maintenance module 150) includes, in one example, various sub-modules to be used to perform automated decision optimization for asset maintenance. The sub-modules are, e.g., computer readable program code (e.g., instructions) in computer readable media, e.g., persistent storage (e.g., persistent storage 113, such as a disk) and/or a cache (e.g., cache 121), as examples. The computer readable media may be part of a computer program product and may be executed by and/or using one or more computers, such as computer(s) 101; processors, such as a processor of processor set 110; and/or processing circuitry, such as processing circuitry of processor set 110, etc.

Example sub-modules of automated decision optimization for asset maintenance module 150 include, for instance, an obtain automated artificial intelligence data sub-module 200 to obtain data from an automated artificial intelligence process that, e.g., performs pre-processing and/or provides output data, including risk estimation for automated decision optimization of one or more assets; an automated model generation sub-module 220 to obtain the data output from sub-module 200 and generate one or more optimization models for asset maintenance, including generating pipelines to produce the models; and a deploy/execute sub-module 230 to deploy and execute a selected optimization model to perform asset maintenance. Although various sub-modules are described, an automated decision optimization for asset maintenance module, such as automated decision optimization for asset maintenance module 150, may include additional, fewer and/or different sub-modules. A particular sub-module may include additional code, including code of other sub-modules, or less code. Further, additional and/or other modules may be used, including but not limited to, an automated artificial intelligence module used to provide data, e.g., a risk estimate, for use by the automatic decision optimization for asset maintenance module. Many variations are possible.

The sub-modules are used, in accordance with one or more aspects of the present invention, to perform automated decision optimization for asset maintenance, as described further described with reference to FIG. 3.

FIG. 3 depicts one example of a process to perform automated decision optimization for asset maintenance, in accordance with one or more aspects of the present invention. The process is executed, in one or more examples, by a computer (e.g., computer 101), and/or a processor or processing circuitry (e.g., of processor set 110). In one example, code or instructions implementing the process are part of a module, such as module 150. In other examples, the code may be included in one or more modules and/or in one or more sub-modules of the one or more modules. Various options are available.

As one example, an automated decision optimization process 300 executing on a computer (e.g., computer 101), a processor (e.g., a processor of processor set 110) and/or processing circuitry (e.g., processing circuitry of processor set 110) obtains (e.g., receives, is sent, is provided, retrieves, etc.) 310 output from an automated artificial intelligence process. The output includes, for instance, data obtained from one or more sources (e.g., sensors, monitors, etc.) that, optionally, has been preprocessed, a risk estimation score and/or a chosen predictive modeling technique. This output (or a selected portion of it) is input to automated decision optimization process 300 that performs 320 optimization modeling to generate a plurality of maintenance solution pipelines and to automatically select a particular maintenance solution pipeline to produce an output (e.g., a model). The output (e.g., the generated model) is deployed and executed 330 to provide an optimized maintenance schedule and/or plan to maintain (e.g., replace, reuse, repair, inspect, etc.) a plurality of assets (e.g., a plurality of interdependent assets). For instance, code and model rendering is initiated and performed for the automatically selected maintenance solution pipeline to provide an optimized maintenance schedule and/or plan.

Further, in one example, automated decision optimization process 300 continues to obtain 340 output from the automated artificial intelligence process, including risk scores. For example, at periodic intervals or based on an update to selected data, such as, e.g., a change in risk scores above/below a threshold, etc., automated decision optimization process 300 obtains the output from the automated artificial intelligence process. Based on obtaining the output, the code and model rendering may be re-initiated 350 while still using the maintenance solution pipeline that was automatically selected. For instance, based on a change in risk scores (e.g., a change above/below a threshold, as an example), automated decision optimization process 300 re-initiates the code and model rendering to provide an output of decision support for one or more assets of a plurality of assets in which a maintenance action of repair, replace, reuse, inspect and/or maintain, etc. is performed.

In one or more aspects, based on obtaining a maintenance plan or schedule, the plan and/or schedule is implemented. For instance, a maintenance action (e.g., repair, replace, reuse, maintain and/or inspect, etc.) specified in the plan or schedule is initiated for a selected environment (e.g., a manufacturing environment, a utility environment, a construction environment, a service environment, a computing environment, etc.). In one example, a maintenance action is initiated by sending (e.g., automatically based on the plan and/or schedule) an indication to commence the action. As an example, the indication is sent by a computer (e.g., computer 101), a processor of a processor set (e.g., processor set 110) and/or processing circuitry of a processor set (e.g., processor set 110) to a computing or electronic component that receives the indication and automatically initiates the action. Alternatively, or additionally, the indication is sent to a maintenance repair person or other entity that initiates the maintenance action.

Based on initiating the maintenance action, the action is performed. As examples, a physical component within a machine or device is inspected, maintained, repaired and/or replaced. This may be performed manually and/or automatically (e.g., using computer code, a robotic device, etc.). Many possibilities exist.

In one or more examples, the plan and/or schedule may be adjusted by, for instance, re-initiating the code and model rendering (and re-using the selected pipeline) based on, e.g., a change in risk scores. The updated plan and/or schedule is then implemented, as described herein, in one example. The re-initiating the code and model rendering while re-using the selected pipeline provides efficiencies within a computer (e.g., within computer processing) and reduces the use of computer resources.

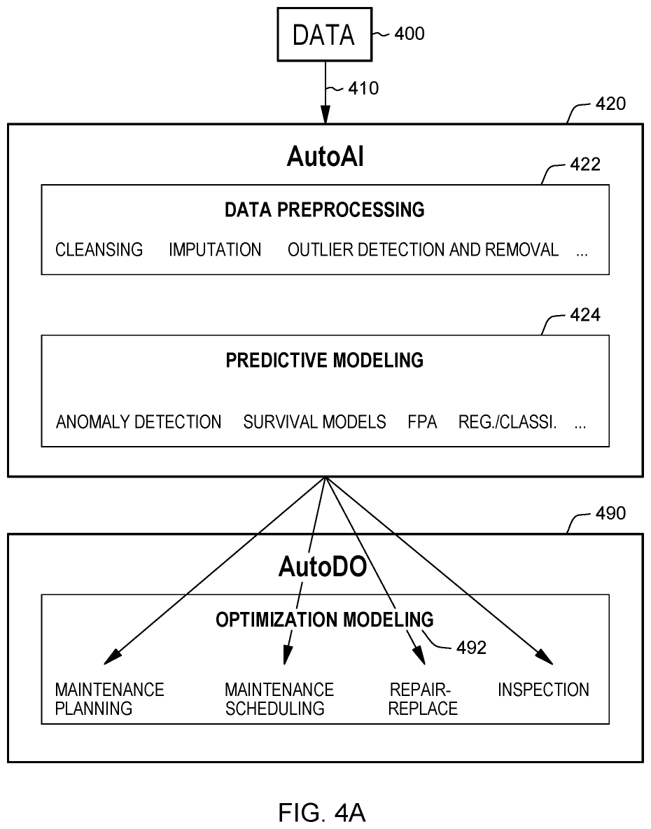

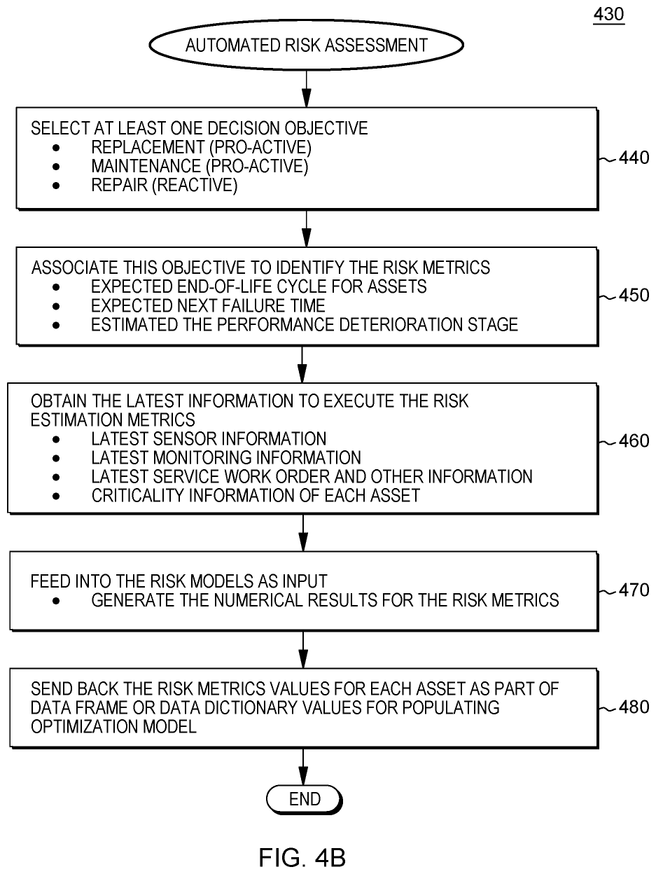

Further details regarding automated decision optimization are described with reference to FIG. 4A. As shown, in one example, data 400 obtained from one or more sources (e.g., sensors of/external to a component/device/machine, monitors of/external to a component/device/machine, input data, etc.) is input 410 to an automated artificial intelligence process 420. Automated artificial intelligence process 420 is a machine learning process that optionally preprocesses 422 the data including, for instance, cleansing the data, imputing the data, detecting one or more outliers and/or removing one or more outliers. Further, automated artificial intelligence process 420 selects and/or uses 424 a predictive modeling technique, such as, for instance, anomaly detection, survival models, failure prevention analysis (fpa), regression/classification, etc. to make one or more predictions relating to the data. As an example, the type of predictive modeling technique chosen is dependent on the problem statement and scope, optimization modeling assumption, type of assets and scalability, and optimization technique performance and scalability.

In one example, automated artificial intelligence process 420 uses predictive modeling to provide a risk estimation (e.g., a score, value, etc.) of one or more conditions (e.g., health, failure, end-of-life cycle, etc.) of one or more assets of e.g., one or more components and/or machines/devices, etc. Referring to FIG. 4B, in one example, an automated risk assessment process 430 performed by automated artificial intelligence process 420 includes, for instance, selecting 440 at least one decision objective: e.g., replacement (pro-active), maintenance (pro-active), repair (reactive), and/or other objectives, and associating 450 the at least one selected decision objective with one or more assets (e.g., a plurality of assets) to identify the risk metrics, such as, e.g., expected end-of-life cycle for assets; expected next failure time; estimated performance deterioration stage, etc.

Further, in one example, automated risk assessment process 430 obtains 460 the latest (e.g., up-to-date) information to execute one or more risk estimation metrics. This latest information includes, for instance, latest sensor information, latest monitoring information, latest service work order and/or other information (e.g., utility, etc.), criticality information of each asset, etc.

Automated risk assessment process 430 feeds 470 into one or more selected risk models the information as inputs and generates numerical results for the risk metrics. The risk models include, for instance, anomaly detection, survival models, failure prevention analysis, regression, classification, as well as others.

Process 430, in one example, sends 480 back the risk metrics values for each asset as part of a data frame or data dictionary values for populating one or more optimization models.

Returning to FIG. 4A, the preprocessed data, including, e.g., risk estimation, and/or the one or more selected predictive modeling techniques, are input to an automated decision optimization process 490 (e.g., automated decision optimization process 300). Automated decision optimization process 490 performs optimization modeling 492 for one or more maintenance tasks, including, but not limited to, maintenance planning and/or maintenance scheduling, such as to repair, replace, reuse, inspect, etc. one or more (e.g., a plurality of) assets.

In one example, each of processes 490, 430 and 420 is executed by a computer (e.g., computer 101), a processor (e.g., of processor set 110) and/or processing circuitry (e.g., of processor set 110). In one example, code or instructions implementing a process are part of a module. For instance, module 150 includes code or instructions for process 490. Module 150 and/or other modules stored in, e.g., persistent storage may include code or instructions for process 430 and/or process 420. In examples, the code may be included in one or more modules and/or in one or more sub-modules of the one or more modules. Various options are available.

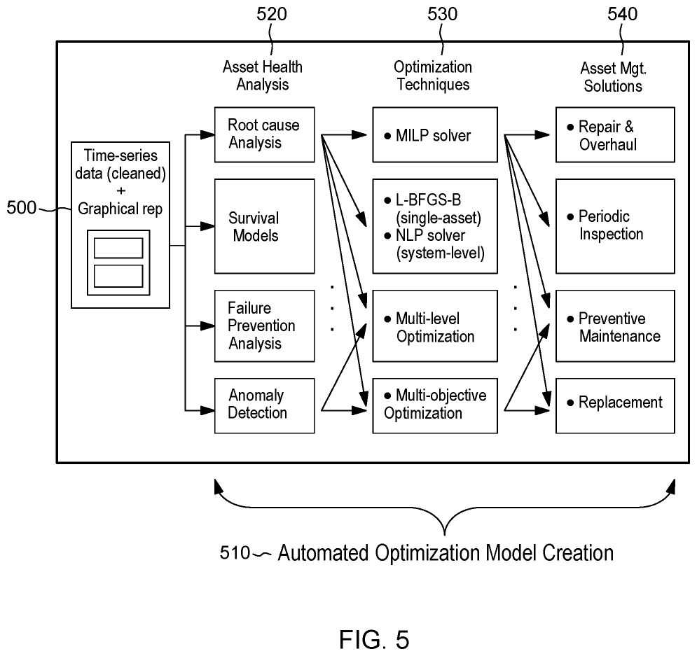

A further depiction of an example of automated decision optimization, including automated optimization model creation, is described with reference to FIG. 5. As shown, data 500, which is, for instance, data preprocessed by an automated artificial intelligence process (e.g., automated artificial intelligence process 420), is input to an automated optimization model creation process 510 that performs asset health analysis 520 (using, e.g., an automated artificial intelligence process, e.g., automated artificial intelligence process 420) and optimization modeling using one or more optimization algorithms 530 to provide asset management solutions 540. Asset health analysis 520 performs, for instance, one or more analyses, including, for example, root cause analysis, survival models, failure prevention analysis, and anomaly detection. Additional, fewer and/or other analyses may be used; those mentioned herein are just some examples.

Output from the asset health analysis is input to one or more optimization techniques 530. Optimization techniques 530 include, but are not limited to, mixed integer linear programming (MILP), L-BFGS-B (Limited-memory BFGS (Broyden-Fletcher-Goldfarb-Shanno)-B), non-linear programming (NLP), multi-level optimization, and multi-objective optimization. Additional, fewer and/or other optimization techniques may be used; those mentioned herein are just some examples.

The one or more optimization techniques generate one or more optimization solutions 540. Example optimization solutions include, but are not limited to, repair and overhaul, periodic inspection, preventive maintenance and replacement. Additional, fewer and/or other optimization solutions may be provided; those mentioned herein are just some examples.

In one example, a graph structure, such as a directed acyclic graph, is used that includes asset health analyses 520, optimization techniques 530 and asset management solutions 540. Based on input, including, for instance, asset data describing the plurality of assets, including asset type; operational data describing operational status of the assets; and/or a set of performance goals and objectives for asset maintenance, the graph is traversed providing a pipeline used to generate a model that provides a solution (e.g., solution 540).

In one or more aspects, automated artificial intelligence and automated decision optimization are used together to define one or more pipelines (e.g., machine learning pipelines) to be used to automatically generate a model for maintenance of physical assets. An automated artificial intelligence process preprocesses the data (e.g., from sensors, monitors, user input, etc.) performs predictive modeling, including, e.g., risk analysis, and provides output that is input to an automated decision optimization process. The automated decision optimization process performs, e.g., optimization modeling to create a model that is reusable. For instance, pipelines are generated to produce the model. The model when deployed and executed produces a solution (e.g., repair and overhaul, inspect, prevent, replace, reuse, etc.).

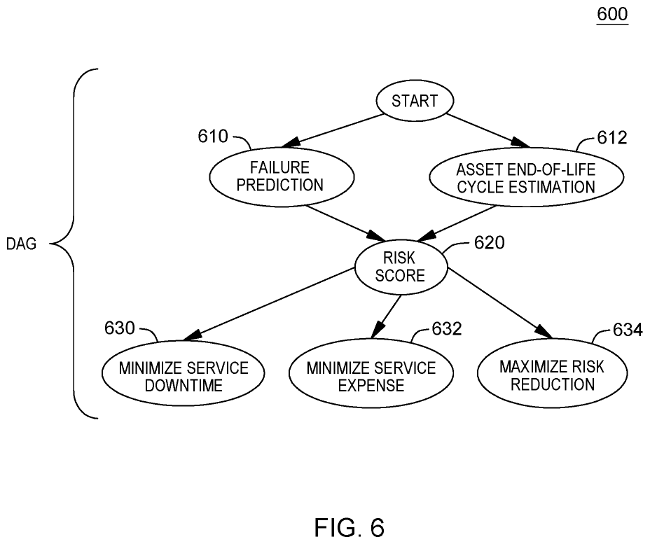

In one aspect, based on, for instance, input data availability and a selected asset management solution, an automated dynamic optimization maintenance pipeline is determined. One example of selecting a pipeline used to provide a solution for asset maintenance is described with reference to FIG. 6. The selection includes, for instance, using an automated artificial intelligence process (e.g., automated artificial intelligence process 420) and an automated decision optimization process (e.g., automated decision optimization process 490) to provide a pipeline to perform automatic optimization of asset maintenance. For instance, output of an automated artificial intelligence process, including risk estimation, is input to an automated decision optimization process.

Referring to FIG. 6, each traversal of a graph structure, such as directed acyclic graph 600, provides a pipeline used to optimize asset maintenance. Directed acyclic graph 600 includes processing of an automated artificial intelligence process (e.g., automated artificial intelligence process 420) that provides a risk score 620 based on, for instance, failure prediction 610 and/or asset end-of-life cycle estimation 612, combined with processing of an automated decision optimization process (e.g., automated decision optimization process 490) that performs optimization modeling, such as, e.g., minimize service downtime 630, minimize service expense 632, and maximize risk reduction 634, to provide a solution.

A pipeline defined and used to maintain an asset depends, for instance, on the scenario. Example scenarios include, but are not limited to, repair/replacement and maintenance cost reduction; repair and maintenance (no replacement) cost reduction; service downtime reduction; and maximum assets fleet health (an asset fleet is a plurality of assets with certain similarities and/or some assets having interdependencies). For each scenario, an optimization model generation pipeline is provided, in accordance with one or more aspects of the present invention. For instance, referring to FIG. 6, for the repair/replacement and maintenance cost reduction scenario, a selected pipeline of a plurality of pipelines includes failure prediction 610 and asset end-life estimation 612, risk score 620 and minimize service expense 632; for the repair and maintenance (no replacement) cost reduction scenario, a selected pipeline includes failure prediction 610, risk score 620 and minimize service expense 632; for the service downtime reduction scenario, a selected pipeline includes failure prediction 610 and asset end-of-life cycle estimation 612, risk score 620 and minimize service downtime 630; and for the service downtime reduction and maximum assets fleet health scenario, a selected pipeline includes failure prediction 610 and asset end-of-life cycle estimation 612, risk score 620 and maximize risk reduction 634. Although various scenarios and/or pipelines are described additional, fewer and/or other scenarios and/or pipelines may be used.

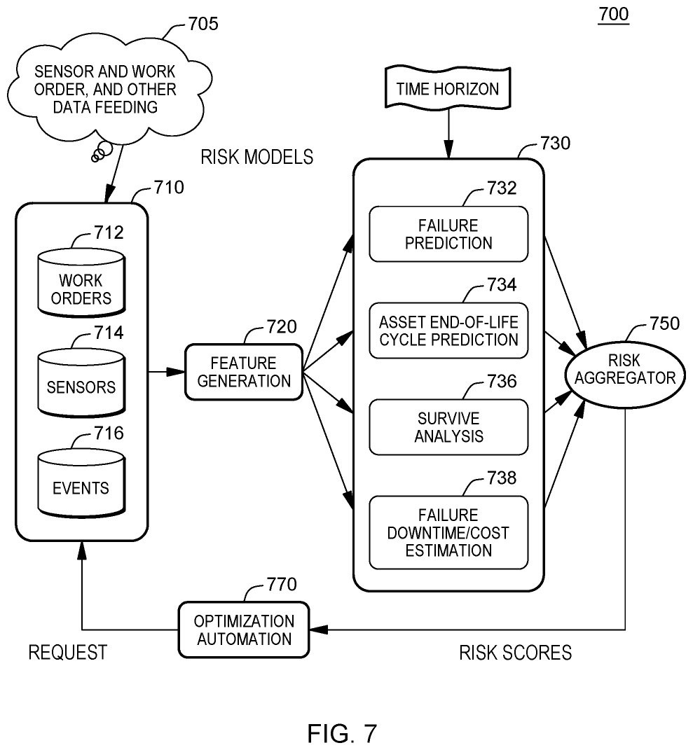

Further details of one example of processing to determine a risk score are described with reference to FIG. 7. In one example, a process 700 obtains 705 data from one or more sources, which is stored in at least one repository 710. The data includes, for instance, data from one or more work orders 712, data from one or more sensors 714 and/or other data, such as data from selected events 716, such as from disasters and/or failure events, data from monitors, etc. Other and/or different data may be obtained and stored. Process 700 inputs at least some of the data to a feature generation process 720, which generates one or more outputs 730, including but not limited to, failure prediction 732, asset end-of-life cycle prediction 734, survive analysis 736 and failure downtime/cost estimation 738. (A feature is data that is based on a given scenario.) Process 700 inputs the one or more outputs 730 to a risk aggregator 750, which produces one or more risk scores 760 using one or more risk modeling techniques, as described herein. Process 700 inputs the one or more risk scores 760 into an automated optimization process (e.g., automated decision optimization process 790). Process 700 may provide information regarding the output from optimization automation process 770 to a repository, such as repository 710.

In one example, process 700 is executed by a computer (e.g., computer 101), a processor (e.g., of processor set 110) and/or processing circuitry (e.g., of processor set 110). In one example, code or instructions implementing the process are part of a module. It may be part of module 150 and/or other modules. In examples, the code may be included in one or more modules and/or in one or more sub-modules of the one or more modules. Various options are available.

As described herein, in one or more aspects, automated decision optimization for asset management includes combining automated artificial intelligence processing (including, but not limited to, risk score processing) and automated decision optimization processing to generate a solution to manage assets, such as to plan or schedule maintenance for assets. In one example, output from the automated artificial intelligence processing is input to automated decision optimization processing.

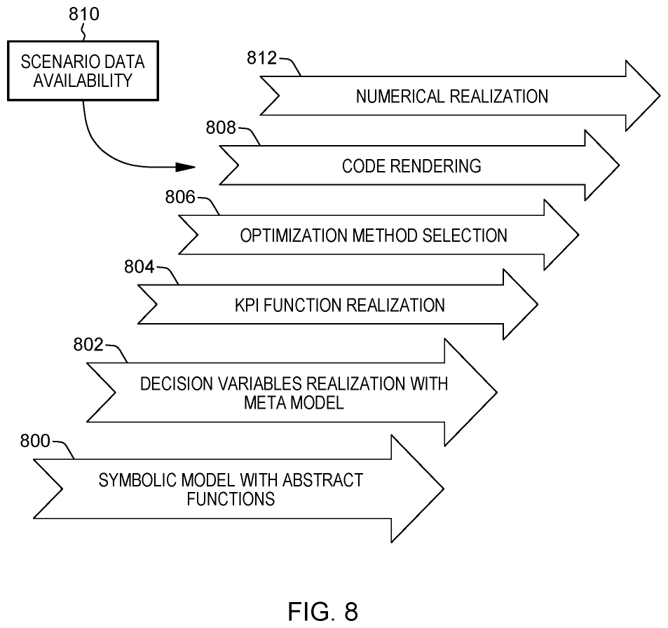

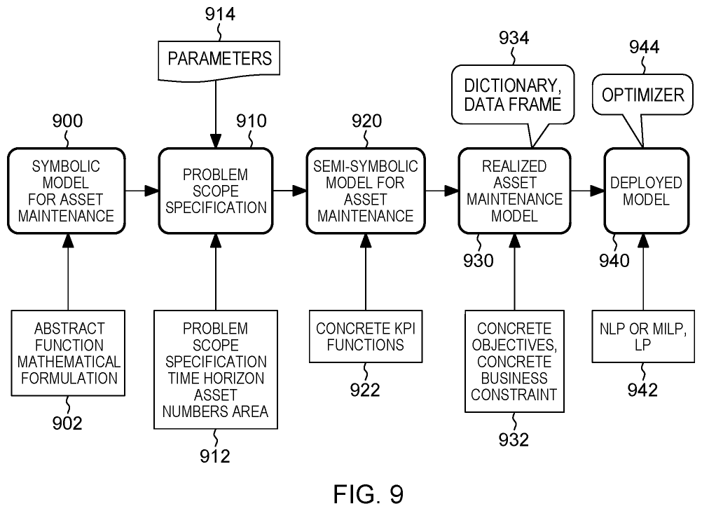

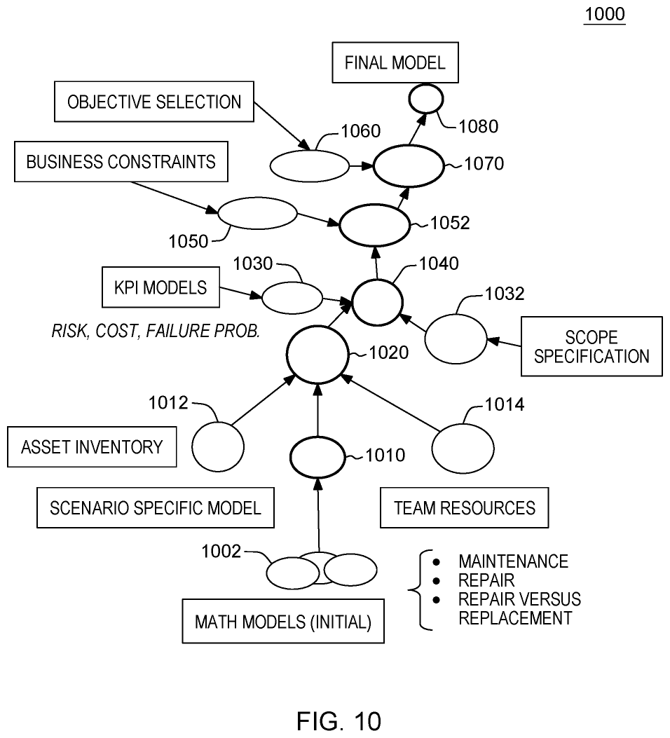

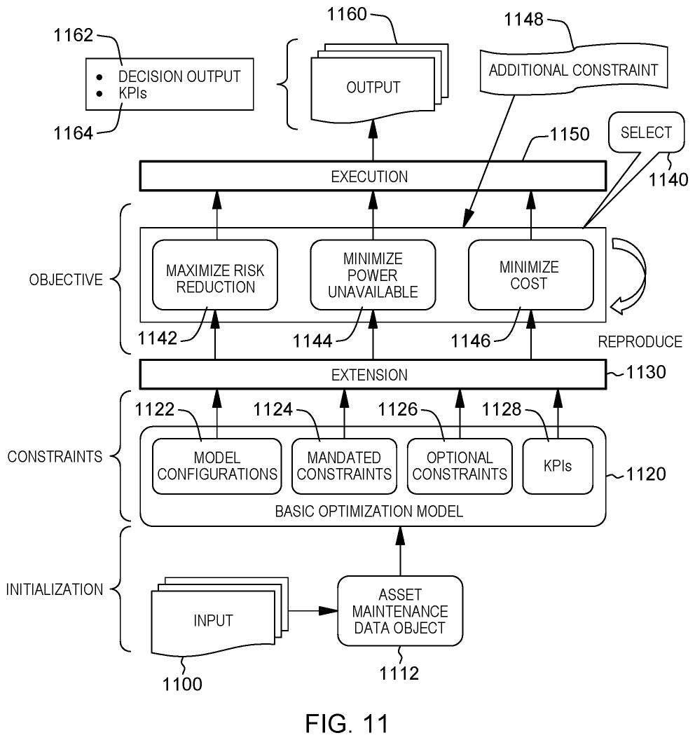

Further details relating to automated decision optimization processing are described with reference to FIGS. 8-11. For instance, one example of a conceptual level of generating an automated decision optimization model is described with reference to FIG. 8; one example of model transformation is described with reference to FIG. 9; one example of a tree structure for an automated decision optimization based pipeline is described with reference to FIG. 10; and one example of condition-based asset management is described with reference to FIG. 11.

Referring to FIG. 8, conceptually to automatically build or re-build a model to perform asset maintenance, in one example, a bottom-up approach is used with multiple layers. In moving up through the layers, the layers and/or structure becomes more specialized. Such a structure enables the data and objectives to change without affecting how the model is built. In one example, at the bottom is a symbolic model with abstract functions layer 800. A next layer is a decision variables realization with meta model layer 802 that indicates what is changing (e.g., data changes, objective changes, etc.). A next layer is a key performance indicators (KPI) function realization layer 804 that specifies the objectives to be realized. A next layer is an optimization method selection layer 806 that indicates the optimization solution that is desired, such as inspect, repair, replace, reuse, etc. A next layer is a code rendering layer 808 that takes into consideration scenario data availability (e.g., risk scores, risk estimates, etc.) 810. A top layer is a numerical realization layer 812 in which a solution is provided. Such a bottom-up approach provides flexibility and extensibility and accounts for changes in data and/or objectives.

One example of transformation of a model to perform asset maintenance is described with reference to FIG. 9. In one example, a symbolic model for asset maintenance 900 receives as input an abstract function 902, such as a mathematical formulation or other function to define the model. Symbolic model 900 is input to a problem scope specification 910 that defines a problem scope specification 912 for a time horizon and specifying asset numbers. Further, one or more parameters 914 related to the scenario may be input to problem scope specification 910. Output of problem scope specification is input to a semi-symbolic model for asset maintenance 920, which receives, for instance, concrete key performance indicators 922. Output of semi-symbolic model for asset management 920 is input to a realized asset maintenance model 930 that receives concrete objectives, concrete constraints (e.g., business and/or other constraints) 932 and dictionary and data inputs (e.g., risk scores, risk estimates, etc.) 934. Output of realized asset maintenance model 930 is input to a deployed model 940. Input to deployed model 940 is a programming model 942, such as a linear programming (LP) model, a non-linear programming (NLP) model or a mixed integer linear programming (MILP) model, and the deployed model is implemented by, e.g., an optimizer (now known or later developed).

In accordance with one or more aspects, a tree structure is defined to generate a model to be used to perform automated decision optimization for asset maintenance. In one example, referring to FIG. 10, a tree structure 1000 includes nodes 1002 for initial models (e.g., initial mathematical models) that may be used, for instance, for maintenance, repair, replace, reuse, etc. Those initial models are input to a scenario specific model 1010 (which is at a non-leaf node of the tree; non-leaf nodes specify model middle points). An inventory 1012 of assets (at a leaf node that depicts change points or an information specific node) and resources 1014 (at another leaf node) are used with scenario specific model 1010 to produce a model middle point 1020. Further, KPI models 1030 (at a leaf node) and scope specification 1032 (at a leaf node) are used with model middle point 1020 to produce another model middle point 1040. That is used with one or more business constraints 1050 (at a leaf node) to produce another model middle point 1052. Next, model middle point 1052 and objective selection 1060 (at a leaf node) are used to provide another middle point model 1070 used to provide a final model 1080. Although one example of a tree structure used to automatically generate a model for one or more scenarios is shown, many other tree structures may be used.

As an example, for a given pipeline, a tree structure (e.g., a directed acyclic graph) is used to manage model building and rebuilding. As an example, the root node of the tree structure presents, for instance, the final realized optimized model. Some nodes represent data collection, preprocessing, imputation, etc. Leaf nodes represent, e.g., an optimization pipeline based on the choice of the risk estimation technique. A non-leaf node is annotated as an operation to define a mathematical representation based on numerical specification, user-defined constraints and objectives. For each non-leaf node, a repository is defined, in one example, for storing an intermediate model. An optimization model update or creation is completed through tree traversal. Such a tree (e.g., graph representation) defines a specific path of uncertainty reduction. The tree traversal is converted to a pipe auto-generation, and the tree is interpretable due to the graph/tree structure.

One example of a realized model generated and used for condition-based asset maintenance is described with reference to FIG. 11. In one example, initialization 1100 begins by providing user input 1110 (e.g., using object notation or other mechanisms) to an asset maintenance data object 1112. Data object 1112 is input to a basic optimization model 1120, in which one or more model configurations and constraints are specified. For instance, basic optimization model 1120 includes, for instance, one or more model configurations 1122, one or more mandated constraints 1124, one or more optional constraints 1126 (e.g., user constraints) and/or one or more key performance indicators 1128. Additional, fewer and/or other information may be provided/used.

Basic optimization model 1120 is input to an extension model 1130, which is used to build/rebuild one or more models based on the objectives. For instance, extension 1130 is used to generate a pipeline and/or model that meets a selected objective 1140, such as a maximize risk reduction objective 1142, a minimize power unavailability objective 1144, or a minimize cost objective 1146, etc. Additional, fewer and/or other objectives may be used. Further, additional constraints 1148 may be considered. Execution 1150 executes the built/rebuilt model to generate output 1160. Output 1160 includes, for instance, decision output 1162 and/or key performance indicators 1164, etc., as examples.

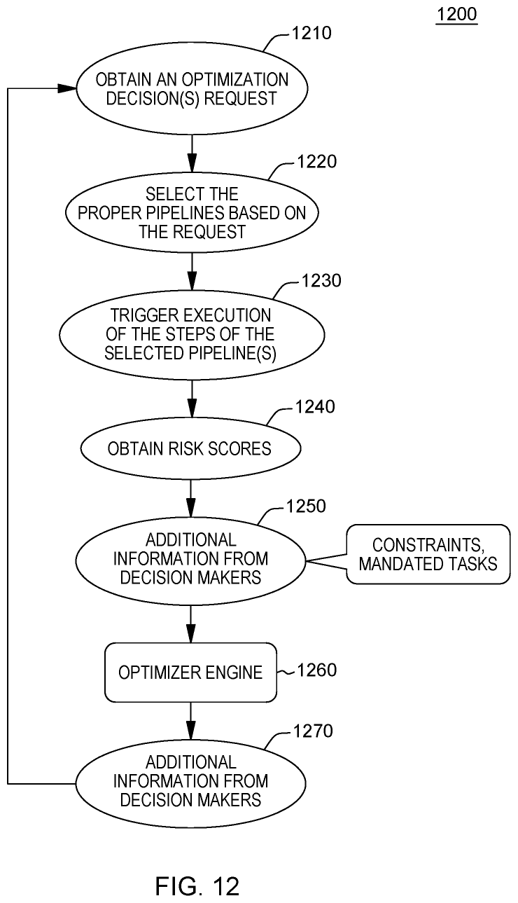

In one or more aspects, automated decision optimization for asset maintenance is invoked based on a request for an optimization decision, as described with reference to FIG. 12. As shown, in one example, a process, such as process 1200, obtains 1210 a request for at least one optimization decision. This request may be provided by a user or automatically determined based on an event, such as an existing event (failure, system slow down, etc.) or a predicted event (failure, system slow down, etc.). Based on obtaining an optimization decision request, process 1200 selects 1220 one or more pipelines, based on the request. For instance, a graph structure (e.g., directed acyclic graph) framework is used to select a pipeline (e.g., the best pipeline based on predefined criteria). The pipeline is selected by, for instance, outlining the process of problem definition to risk and optimization modeling, in which user inputs and derived information on problem definition determine a relevant branch of the graph structure to be traversed. The selected (e.g., best) pipeline is determined by input data availability and a selected asset maintenance solution. A graph structure (e.g., directed acyclic graph) based system is used to assist with the automated identification and development of decision variables, key performance indicators, constraints, objective function(s), risk estimation models and corresponding constraints as part of an optimization object based on abstract representation of problem scope, time horizon, asset types and features, and data. The graph framework is to select the best pipeline, in which user inputs determine the decision made within the system on the graph structure.

Process 1200 triggers execution 1230 of steps of the selected pipeline(s).

Further, in one example, process 1200 obtains 1240 one or more risk scores provided by artificial intelligence processing. The risk scores may be based, for instance, on user input and/or learned data from previous and/or other processing. Process 1200 may also obtain 1250 addition information from one or more decision makers, including, but not limited to, constraints, mandated tasks, etc. Process 1200 inputs 1260 the risk score(s) and/or the additional information to an optimizer engine to determine one or more solutions.

Further, in one example, process 1200 may receive 1270 additional information from one or more decision makers and based thereon, a decision may be made to repeat the process. Other variations are possible.

In one example, process 1200 is executed by a computer (e.g., computer 101), a processor (e.g., of processor set 110) and/or processing circuitry (e.g., of processor set 110). In one example, code or instructions implementing the process are part of a module, such as module 150 and/or other modules. In other examples, the code may be included in one or more modules and/or in one or more sub-modules of the one or more modules. Various options are available.

Described above is one example of a process used to build/re-build a model to be used to maintain assets or perform other management tasks. One or more aspects of the process may use machine learning. For instance, machine learning may be used to determine risk scores, perform predictive modeling, perform optimization modeling, determine constraints and/or perform other tasks. A system is trained to perform analyses and learn from input data and/or choices made.

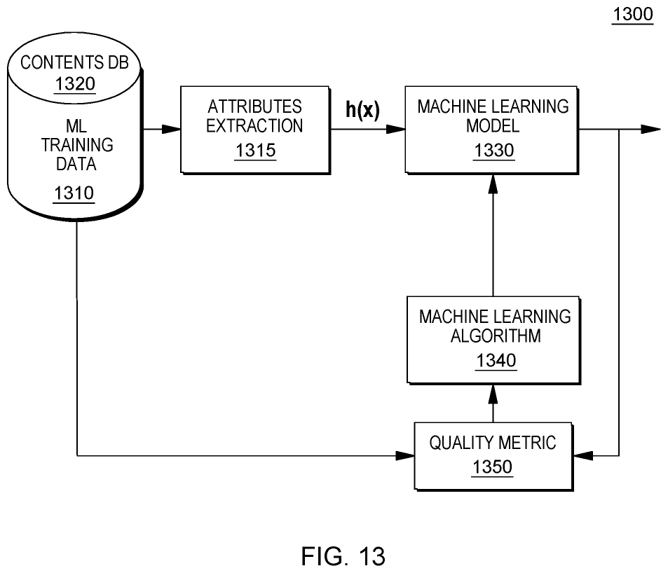

FIG. 13 is one example of a machine learning training system 1300 that may be utilized, in one or more aspects, to perform cognitive analyses of various inputs, including data from one or more data structures and/or other data. Training data utilized to train the model in one or more embodiments of the present invention includes, for instance, data that pertains to one or more events, such as data used to populate the data structures, etc. The program code in embodiments of the present invention performs a cognitive analysis to generate one or more training data structures, including algorithms utilized by the program code to predict states of a given event. Machine learning (ML) solves problems that are not solved with numerical means alone. In this ML-based example, program code extracts various attributes from ML training data 1310 (e.g., historical data collected from various data sources relevant to the event), which may be resident in one or more databases 1320 comprising event or task-related data and general data. Attributes 1315 are utilized to develop a predictor function, h(x), also referred to as a hypothesis, which the program code utilizes as a machine learning model 1330.

In identifying various event states, features, constraints and/or behaviors indicative of states in the ML training data 1310, the program code can utilize various techniques to identify attributes in an embodiment of the present invention. Embodiments of the present invention utilize varying techniques to select attributes (elements, patterns, features, constraints, etc.), including but not limited to, diffusion mapping, principal component analysis, recursive feature elimination (a brute force approach to selecting attributes), and/or a Random Forest, to select the attributes related to various events. The program code may utilize a machine learning algorithm 1340 to train the machine learning model 1330 (e.g., the algorithms utilized by the program code), including providing weights for the conclusions, so that the program code can train the predictor functions that comprise the machine learning model 1330. The conclusions may be evaluated by a quality metric 1350. By selecting a diverse set of ML training data 1310, the program code trains the machine learning model 1330 to identify and weight various attributes (e.g., features, patterns, constraints) that correlate to various states of an event.

The model generated by the program code is self-learning as the program code updates the model based on active event feedback, as well as from the feedback received from data related to the event. For example, when the program code determines that there is a constraint that was not previously predicted by the model, the program code utilizes a learning agent to update the model to reflect the state of the event, in order to improve predictions in the future. Additionally, when the program code determines that a prediction is incorrect, either based on receiving user feedback through an interface or based on monitoring related to the event, the program code updates the model to reflect the inaccuracy of the prediction for the given period of time. Program code comprising a learning agent cognitively analyzes the data deviating from the modeled expectations and adjusts the model to increase the accuracy of the model, moving forward.

In one or more embodiments, program code, executing on one or more processors, utilizes an existing cognitive analysis tool or agent (now known or later developed) to tune the model, based on data obtained from one or more data sources. In one or more embodiments, the program code interfaces with application programming interfaces to perform a cognitive analysis of obtained data. Specifically, in one or more embodiments, certain application programming interfaces comprise a cognitive agent (e.g., learning agent) that includes one or more programs, including, but not limited to, natural language classifiers, a retrieve and rank service that can surface the most relevant information from a collection of documents, concepts/visual insights, trade off analytics, document conversion, and/or relationship extraction. In an embodiment, one or more programs analyze the data obtained by the program code across various sources utilizing one or more of a natural language classifier, retrieve and rank application programming interfaces, and trade off analytics application programming interfaces. An application programming interface can also provide audio related application programming interface services, in the event that the collected data includes audio, which can be utilized by the program code, including but not limited to natural language processing, text to speech capabilities, and/or translation.

In one or more embodiments, the program code utilizes a neural network to analyze event-related data to generate the model utilized to predict the state of a given event at a given time. Neural networks are a biologically-inspired programming paradigm which enable a computer to learn and solve artificial intelligence problems. This learning is referred to as deep learning, which is a subset of machine learning, an aspect of artificial intelligence, and includes a set of techniques for learning in neural networks. Neural networks, including modular neural networks, are capable of pattern recognition with speed, accuracy, and efficiency, in situations where data sets are multiple and expansive, including across a distributed network, including but not limited to, cloud computing systems. Modern neural networks are non-linear statistical data modeling tools. They are usually used to model complex relationships between inputs and outputs or to identify patterns in data (i.e., neural networks are non-linear statistical data modeling or decision making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in multiple source processing, which the program code in one or more embodiments accomplishes when obtaining data and generating a model for predicting states of a given event.

As described above, automated decision optimization is provided that automates model generation/re-generation for selected scenarios, such as the maintenance of physical assets. The generated models are prediction-optimization models that leverage data pre-processing and predictive capabilities of automated artificial intelligence. In creating the model, a predictive modeling technique is chosen that is based on, e.g., problem statement/scope; optimization modeling assumptions; asset type and scalability; and/or optimization algorithm performance and scalability.

In one or more aspects, to produce the model, a pipeline is selected (e.g., automatically). The pipeline is, e.g., a machine learning pipeline that includes steps to perform, e.g., data preprocessing, model build training, model deployment, etc. The selected pipeline codifies and automates the model. In one or more aspects, asset management optimization generation is streamlined by providing a well-proven methodology that can enhance productivity and reduce the time of turn-around for asset management model creation.

In one or more aspects, an optimized asset maintenance plan for a set of physical assets is generated. The generating includes, for instance, receiving asset data describing a plurality of physical assets, including asset type; receiving operational data describing the operational status of the physical assets; receiving a set of performance goals and strategic objectives for asset maintenance; identifying a selected optimization model by selecting an optimization model from a plurality of candidate optimization models based on an evaluation of the asset data, performance goals, and strategic business objectives; identifying constraints and objectives to be used/considered by the selected optimization model; receiving selected optimization model constraint and objective values specific to the set of assets; and generating an asset management plan by applying the selected optimization model to the operational data.

In one or more aspects, automatic decision optimization for asset maintenance (e.g., conditional asset maintenance) includes, for instance, defining a graph structure (e.g., a directed acyclic graph) to define the information collection process, in which each node is composed as a fully ordered sequence. For each leaf node, a function or action for information fetch is defined to obtain the latest data for the optimization objective, constraint and/or regression model(s). For each non-leaf node, a repository for storing the intermediate model is defined, as well as the representation of each non-leaf node. A model assembly is completed from a middle point of the graph. A complete assembly is defined as a full tree walk from the non-leaf node and is to cover the nodes that have a node ID higher, as an example, than the selected non-leaf node. A reuse score is determined which is a ratio of the nodes to be walked to the maximum number of nodes. Reusability may be quantified.

Utilization of a graph structure, such as a directed acyclic graph, for decision making simplifies the process of automated generation of asset optimization management models for an asset fleet. It enables, for instance, an analyst and/or others to be removed from the decision-making process and lets the user inputs and/or derived information determine how to build reusable models for a given use case. A design of the specific graph structure and meta model maximizes the use of conditional asset management optimization modeling efforts using a meta optimization model for various scenarios. Adaptive creation of decision variables, constraints and objectives, as well as risk models based on user inputs is provided. Automated build and rebuild models based on real-time data ingestion and processing are provided.

In one or more aspects, a working flow generated from a pipeline for assembly of an optimization model and execution with a decision optimization pipeline is provided. Such a flow simplifies effort and time involved in building asset fleet maintenance planning models for different use cases (e.g., with different types of risk models and/or different objectives, constraints and/or decision variables); provides efficiencies in making one or more changes to an asset maintenance model; allows changes to part of the components without regeneration of other parts; and aligns with the scenario for model selection (e.g., select from a list of models, such as risk and/or failure models).

Providing the components of an asset maintenance model (e.g., conditional asset maintenance model) with meta design of the components and real instances of the model components in storage maximizes the reuse of the existing optimization components. Each model includes, for instance, a component ID. An indication is provided of how to save the models and what to save to reuse the models. Models may be re-run from a point at which a change occurs.

In one or more aspects, user input based tree structure traversal over, e.g., a directed acyclic graph for an asset maintenance use-case includes, for instance, defining a problem in which the input includes data, problem definition, scope and scale and the output includes problem type control/decision variables, time horizon for scheduling.

For a planning optimization: an optimization model is provided in which the inputs include, for instance, control/decision variables, covariates, dependent variables and/or derived variates and the outputs include, for instance, static failure risk scores/linear functions by asset type; constraints are generated in which the inputs include, for instance, control/decision variables, risk scores/functions and/or operational restrictions and the outputs include, for instance, constraints base on risk model type, business constraint, and/or bounds; one or more objectives are defined in which the inputs include, for instance, control/decision variables and/or one or more operational objectives and the output includes, for instance, a single or multi-objective function. The model is solved by, for instance, an optimization solver.

For a scheduling optimization: an optimization model is provided in which the inputs include, for instance, control/decision variables, covariates, dependent variables and/or derived variates and the outputs include, for instance, failure risk functions by asset type; constraints are generated in which the inputs include, for instance, control/decision variables, risk scores/functions, one or more constraints, admittance, loading and/or demand constraints and the outputs include, for instance, constraints based on risk model type, business constraint and/or bounds; one or more objectives are defined in which the inputs include, for instance, control/decision variables and/or one or more operational objectives and the output includes, for instance, a single or multi-objective function. The model is solved by, for instance, a decomposition approach. In one example, a main problem determines maintenance intervals and a subproblem determines schedules. In another example, a main problem determines schedules and a subproblem is a capacitated network flow problem.

One or more aspects allow for flexibility in terms of risk model types, optimization modeling techniques, problem type (e.g., planning and scheduling), decision variables, etc.

In one or more aspects, condition-based maintenance for an asset fleet is facilitated, in which the asset fleet may have a large number of assets of varying ages, each with one or more health-related sensor signals, assets that are geographically distributed in a large area, affecting maintenance schedules; dependencies and interactions between assets that impact maintenance downtimes, schedules and network reliability, and a desire to minimize the unscheduled downtime due to asset failure. The use of automated artificial intelligence and automated decision optimization offers flexibility in terms of scope, time horizon, risk estimators, and/or operational constraints, etc. Real-time automated artificial intelligence and automated decision optimization deployment is supported. Data retrieval is integrated with the processes, in one example, and model reuse is streamlined.

In one or more aspects, automated decision optimization is provided for a fleet of assets, including scenarios where interdependencies may exist between assets. Tasks of failure risk estimation and subsequent maintenance optimization planning for the asset fleet are performed. A tree structure for decision making is used and enables reuse based on one or more changes (e.g., changes to risk scores, one or more objectives, one or more constraints, etc.).

One or more aspects of the present invention are tied to computer technology and facilitate processing within a computer, improving performance thereof. In one or more aspects, automated processing is performed to manage physical assets including, but not limited to, computers/computer components, machine/components, and/or devices/components, etc. Processing within a processor, computer system and/or computing environment is improved.

Other aspects, variations and/or embodiments are possible.

The computing environments described herein are only examples of computing environments that can be used. One or more aspects of the present invention may be used with many types of environments. The computing environments provided herein are only examples. Each computing environment is capable of being configured to include one or more aspects of the present invention. For instance, each may be configured to provide an automated decision optimization process and/or to perform to one or more other aspects of the present invention.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other predictive and/or modeling techniques may be used. Further, additional, fewer and/or other tasks may be considered. Moreover, other environments may use and benefit from one or more aspects of the present invention. Additionally, although example computers, processors, and/or processing circuitry are indicated, additional, fewer and/or other computers, processors, processing circuitry, etc. may be used to perform one or more aspects of the present invention. For instance, one or more servers (e.g., remote server 104 and/or other servers) may perform one or more aspects of the present invention, including but not limited to, risk assessment and/or automated artificial intelligence processing. Further, one or more computers, servers, processors, processing circuitry, etc. may be used to perform one or more aspects of the present invention. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
automatically selecting a maintenance solution pipeline from a plurality of maintenance solution pipelines based on obtained information, the maintenance solution pipeline to be used in providing a physical asset maintenance solution for a plurality of physical assets;
initiating code and model rendering for the maintenance solution pipeline automatically selected;
obtaining output from an artificial intelligence process, the output including an automatically generated risk estimation relating to one or more conditions of at least one physical asset of the plurality of physical assets; and
re-initiating code and model rendering for the maintenance solution pipeline, based on the output from the artificial intelligence process, wherein the maintenance solution pipeline automatically selected is reused.

2. The computer-implemented method of claim 1, wherein the physical asset maintenance solution includes a condition-based maintenance plan for the plurality of physical assets, at least a portion of the plurality of physical assets being interdependent.

3. The computer-implemented method of claim 1, wherein the physical asset maintenance solution includes a condition-based maintenance schedule for the plurality of physical assets, at least a portion of the plurality of physical assets being interdependent.

4. The computer-implemented method of claim 1, wherein the obtained data includes an obtained risk estimation relating to one or more conditions of one or more physical assets of the plurality of physical assets.

5. The computer-implemented method of claim 1, wherein the automatically selecting the maintenance solution pipeline is further based on asset interdependencies of the plurality of physical assets.

6. The computer-implemented method of claim 5, wherein the automatically selecting the maintenance solution pipeline is further based on a problem definition and is defined for a selected time period.

7. The computer-implemented method of claim 1, wherein the automatically selecting the maintenance solution pipeline comprises traversing a tree structure to select the maintenance solution pipeline.

8. The computer-implemented method of claim 7, wherein the tree structure comprises a directed acyclic graph.

9. The computer-implemented method of claim 1, further comprising creating at least one maintenance solution pipeline, wherein the creating comprises regenerating an existing maintenance solution pipeline based on one or more updated constraints.

10. The computer-implemented method of claim 9, wherein the regenerating is further based on one or more updated objectives.

11. A computer system comprising:
a memory; and
one or more processors in communication with the memory, wherein the computer system is configured to perform a method, said method comprising:
automatically selecting a maintenance solution pipeline from a plurality of maintenance solution pipelines based on obtained information, the maintenance solution pipeline to be used in providing a physical asset maintenance solution for a plurality of physical assets;
initiating code and model rendering for the maintenance solution pipeline automatically selected;
obtaining output from an artificial intelligence process, the output including an automatically generated risk estimation relating to one or more conditions of at least one physical asset of the plurality of physical assets; and
re-initiating code and model rendering for the maintenance solution pipeline, based on the output from the artificial intelligence process, wherein the maintenance solution pipeline automatically selected is reused.

12. The computer system of claim 11, wherein the automatically selecting the maintenance solution pipeline is further based on asset interdependencies of the plurality of physical assets.

13. The computer system of claim 11, wherein the automatically selecting the maintenance solution pipeline comprises traversing a tree structure to select the maintenance solution pipeline.

14. The computer system of claim 13, wherein the tree structure comprises a directed acyclic graph.

15. The computer system of claim 11, wherein the method further comprises creating at least one maintenance solution pipeline, wherein the creating comprises regenerating an existing maintenance solution pipeline based on one or more updated constraints.

16. A computer program product comprising:
one or more computer readable storage media and program instructions collectively stored on the one or more computer readable storage media readable by at least one processing circuit to perform a method comprising:
automatically selecting a maintenance solution pipeline from a plurality of maintenance solution pipelines based on obtained information, the maintenance solution pipeline to be used in providing a physical asset maintenance solution for a plurality of physical assets;
initiating code and model rendering for the maintenance solution pipeline automatically selected;
obtaining output from an artificial intelligence process, the output including an automatically generated risk estimation relating to one or more conditions of at least one physical asset of the plurality of physical assets; and
re-initiating code and model rendering for the maintenance solution pipeline, based on the output from the artificial intelligence process, wherein the maintenance solution pipeline automatically selected is reused.

17. The computer program product of claim 16, wherein the automatically selecting the maintenance solution pipeline is further based on asset interdependencies of the plurality of physical assets.

18. The computer program product of claim 16, wherein the automatically selecting the maintenance solution pipeline comprises traversing a tree structure to select the maintenance solution pipeline.

19. The computer program product of claim 18, wherein the tree comprises a directed acyclic graph.

20. The computer program product of claim 16, wherein the method further comprises creating at least one maintenance solution pipeline, wherein the creating comprises regenerating an existing maintenance solution pipeline based on one or more updated constraints.
